(19) United States
(12) Patent Application Publication
(10) Pub. No.: US 2025/0348788 A1
(43) Pub. Date: Nov. 13, 2025

(54) Machine Learned Models For Generative User Interfaces

(71) Applicant: Google LLC, Mountain View, CA (US)

(72) Inventors: Joshua Rowe, Boulder, CO (US); Todd Preston Shaiman, Denver, CO (US); Min Ji Hong, San Francisco, CA (US); Karen Angeli Vertierra, Mission Viejo, CA (US); Benjamin Guy Alexander Pawle, London (GB); Michael Colville, London (GB); George Joseph Rickerby, London (GB)

(21) Appl. No.: 19/205,602

(22) Filed: May 12, 2025

Related U.S. Application Data
(60) Provisional application No. 63/645,338, filed on May 10, 2024.

(51) Int. Cl. G06N 20/00

(52) U.S. Cl. CPC G06N 20/00

(57) ABSTRACT

Aspects of the disclosed technology include machine-learning systems and methods for generating user interface elements that allow user control over generative content creation by machine-learned generative models. A generative user interface (UI) system is configured to generate, as output of one or more machine-learned sequence processing models, computer-executable functional code to process a user query in association with a content item. The system is configured to generate computer-executable interface code for a user interface that includes a user interface element associated with at least one parameter of the computer-executable functional code for modifying the content item. The system is configured to determine data for the at least one parameter of the computer-executable functional code based at least in part on a user input to the user interface element and generate a modified content item using the computer-executable functional code and the data for the at least one parameter.

### PRIORITY CLAIM

The present application claims priority to U.S. Patent Application No. 63/645,338, entitled “Machine-Learned Models for Generative User Interfaces,” having a filing date of May 10, 2024, which is incorporated by reference herein.

### FIELD

The present disclosure relates generally to machine learning processes and machine-learned devices and systems. More particularly, the present disclosure relates to machine-learned models and generative user interfaces.

### BACKGROUND

Artificial intelligence systems increasingly include large foundational machine-learned models which have the capability to provide a wide range of new product experiences. As an example, machine-learned generative models have proven successful at generating content including text, images, video, audio, computer-executable code, etc. Traditional user interactions with these models have been “one-shot” or transactional in nature. For example, a user may formulate a user query into a prompt which is provided to the model and a response including the generative content is received. If changes are to be made to the generative content, a new user query is formulated and submitted to the model to receive another response including generative content responsive to the new user query. While effective at generating content, these one-shot approaches may not sufficiently surface to users the diverse capabilities of models for generating content. Moreover, such approaches can lead to inefficient computing in some cases as a model may be queried many times before it generates a suitable result for the user's needs.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method performed by one or more processors. The method includes receiving a user query associated with a content item, providing the user query and the content item as input to one or more machine-learned sequence processing models, generating, as output of the one or more machine-learned sequence processing models, computer-executable functional code configured to process the user query in association with the content item, and generating computer-executable interface code for a user interface. The user interface includes a user interface element that is associated with at least one parameter of the computer-executable functional code for modifying the content item. The method includes determining data for the at least one parameter of the computer-executable functional code based at least in part on a user input to the user interface element and generating a modified content item using the computer-executable functional code and the data for the at least one parameter.

Another example aspect of the present disclosure is directed to a computing system including one or more processors, and one or more non-transitory computer-readable storage media that collectively store instructions that, when executed by the one or more processors, cause the one or more processors to perform operations. The operations include receiving a user query associated with a content item, providing the user query and the content item as input to one or more machine-learned sequence processing models, generating, as output of the one or more machine-learned sequence processing models, computer-executable functional code configured to process the user query in association with the content item, and generating computer-executable interface code for a user interface. The user interface includes a user interface element that is associated with at least one parameter of the computer-executable functional code for modifying the content item. The operations include determining data for the at least one parameter of the computer-executable functional code based at least in part on a user input to the user interface element and generating a modified content item using the computer-executable functional code and the data for the at least one parameter.

Yet another example aspect of the present disclosure is directed to one or more non-transitory computer-readable storage media that store instructions that, when executed by one or more processors, cause the one or more processors to perform operations. The operations include receiving a user query associated with a content item, providing the user query and the content item as input to one or more machine-learned sequence processing models, generating, as output of the one or more machine-learned sequence processing models, computer-executable functional code configured to process the user query in association with the content item, and generating computer-executable interface code for a user interface. The user interface includes a user interface element that is associated with at least one parameter of the computer-executable functional code for modifying the content item. The operations include determining data for the at least one parameter of the computer-executable functional code based at least in part on a user input to the user interface element and generating a modified content item using the computer-executable functional code and the data for the at least one parameter.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 is a block diagram depicting an example computing environment including a generative user interface system including a machine-learned sequence processing according to example embodiments of the present disclosure;

FIGS. 2A-2D are block diagrams depicting an example computing environment including a data flow for generating computer-executable functional code and interface code according to example embodiments of the present disclosure;

FIG. 3 is a block diagram depicting an example computing environment including a machine-learned sequence processing model configured to process prompts including API descriptions for external toolboxes according to example embodiments of the present disclosure;

FIG. 4 is a block diagram depicting an example computing environment including a data store for storing functional code and/or interface code generated according to example embodiments of the present disclosure;

FIG. 5 is a graphical depiction of a computing environment including an interface of a generative user interface system according to an example implementation of the disclosed technology;

FIGS. 6A-6D are graphical depictions of a computing environment and an example of processing a user interaction with a generative user interface system according to an example implementation of the disclosed technology.

FIGS. 7A-7C are graphical depictions of a computing environment and an example of processing a user interaction with a generative user interface system according to an example implementation of the disclosed technology;

FIG. 8 is a flowchart diagram depicting an example method of generating computer-executable functional code and interface code according to example embodiments of the present disclosure;

FIG. 9 is a flow chart diagram illustrating an example method for training a machine-learned model according to example implementations of aspects of the present disclosure;

FIG. 10 is a block diagram of an example processing flow for using machine-learned model(s) to process input(s) to generate output(s) according to example embodiments of the present disclosure;

FIG. 11 is a block diagram of an example sequence processing model according to example embodiments of the present disclosure;

FIG. 12 is a block diagram of an example technique for populating an example input sequence for processing by a sequence processing model according to example embodiments of the present disclosure;

FIG. 13 is a block diagram of an example model development platform according to example embodiments of the present disclosure;

FIG. 14 is a block diagram of an example training workflow for training a machine-learned model according to example embodiments of the present disclosure;

FIG. 15 is a block diagram of an inference system for operating one or more machine-learned model(s) to perform inference according to example embodiments of the present disclosure;

FIG. 16 is a block diagram of an example networked computing system according to example embodiments of the present disclosure;

FIG. 17 is a block diagram of an example computing device according to example embodiments of the present disclosure; and

FIG. 18 is a block diagram of an example computing device according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

### Overview

Generally, the present disclosure is directed to machine-learning systems and methods for generating user interface elements that allow user control over generative content creation by machine-learned generative models. More particularly, the present disclosure is directed to machine-learning systems and methods for generating computer-executable functional code for modifying content and computer-executable interface code for a user interface that is configured to receive parameter values for modifying the content using the functional code. A machine-learned system in accordance with embodiments of the present disclosure can receive an indication of user intent such as a user query for one or more machine-learned generative model(s), such as a request to process a content item. The user query can be provided to a machine-learned sequence processing model such as a large language model. The sequence processing model can generate code for a user interface that can surface options to a user that enable real-time graduated control of the machine-learned generative model(s). By way of example, a user query may include a request to enhance an input image. The sequence processing model can generate code for a user interface that includes a user interface element that allows the user to control an amount of image enhancement performed by a generative model processing the user query. The sequence processing model can parse the user's intent to find any aspects that can be parameterized, including but not limited to amounts, suggestions, additive parameters, etc. that correspond directly to a user's intent or things that are beyond what the user directly requested.

Recent advancements in machine-learning capabilities, particularly those of machine-learned generative models including machine-learned sequence processing models (e.g., large language models), image generation models (e.g., text-to-image models), audio generation models (e.g., text-to-audio models), etc. have led to an ever-increasing amount of content generation and modification capabilities. Machine-learned generative models are capable of producing a vast array of diverse capabilities. Traditional interactions with these models are predominantly one-shot interactions in which a user submits a query and receives a result. If the user wishes to alter the result, the user submits a new query and the generative model produces a new result. Such architectures can fail to expose the opportunity space for diverse outcomes that the underlying models are capable of producing.

Embodiments of the present disclosure provide machine-learned model generation of user interfaces that can surface the opportunity space of machine-learned generative models to generate diverse outcomes in response to user queries. A machine-learned generative user interface system is provided that can generate user interface elements in real-time to allow real-time graduated control of a generative model when processing a user query. The system can be configured to generate a user interface in response to a user query that requests processing of a content item by a machine-learned generative model. The system can generate user interface elements that provide human-to-model expressivity, allowing the user to control one or more parameters of the generative model. By way of example, a user interface element can allow a user to gradually shift the output of a model across a continuous spectrum by controlling the prompt and parameters of the generative model. Such a user interface can provide affordances for finer-grained controls that transform the traditional “slot machine” or “one-shot” interactions with machine-learned models into spectrums of control that users can explore and traverse.

In accordance with an example implementation of the disclosed technology, a generative user interface system can include one or more machine-learned sequence processing models such as a large language model (LLM) that is configured to process user queries and generate one or more generative outputs. The LLM can be configured to receive prompts that include text, audio, image data, and/or video data and generate outputs that include text, audio, image, and/or video data. In response to a user query associated with a content item such as an image, video, audio, and/or text item, the sequence processing model can generate computer-executable functional code that facilitates processing of the content item based on the user query. For instance, a prompt can be received that includes an input image and a user query to “add flowers to [this image].” In response, the sequence processing model can generate functional code for editing the image to add flowers. In some examples, the functional code can include one or more calls to one or more external toolboxes such as a machine-learned generative model that is configured to process queries and generate content (e.g., by modifying an image) or conventional tool (e.g., graphics library for image processing). The sequence processing model can also generate computer-executable interface code for a user interface that includes one or more user interface elements for controlling the functional code. For example, the user interface can include a user interface element to control a parameter in the functional code that affects an amount of flowers added to the image.

In accordance with an example implementation of the disclosed technology, a machine-learning generative user interface system can receive an indication of user intent such as a user query in association with a content item. The user query can indicate a context associated with the content item. For example, the content item and a text component of the user query can be provided as an input prompt to a machine-learned large language model (LLM). Continuing with the above example, an input image and text query “add flowers to [this image]” can be provided as an input prompt to the LLM. The LLM can generate computer-executable code that includes a call to an external machine-learned image editing model including the text and image as a prompt. An initial output image can be generated and provided in response to the user query. In addition, the LLM can generate parameter or option descriptions for one or more controllable parameters of the functional code. By way of example, the LLM can generate a parameter description for an “amount” parameter that controls the amount of flowers added to the image. The LLM can also generate computer-executable interface code for a user interface that includes one or more user interface elements for controlling the parameters in the parameter description. For example, the interface code can define a “slider” graphical user interface element that is configured to receive user input via a slider that controls the “amount” parameter. The user interface can be rendered and displayed to the user for controlling the graphical user interface elements. Additionally or alternatively, the system can parse the user's intent and generate suggestions or additive parameters beyond what the user original asked. For instance, the system may generate suggestions such as to “add trees” to the image or generate additive parameters allowing the user to select types of flowers, colors, etc.

The LLM can generate parameter or option descriptions to generate controllable parameters of the functional code based on a semantic understanding of the query. In this manner, the LLM can generate content-aware parameters. Consider an example of an input image and a user query to “show me what this city would look like if designed by famous architects.” The LLM can semantically interpret the user query and generate a list of famous architects to select from. Subsequently, the LLM can use inputs to the list to generate an image prompt to regenerate an image in the style of a selected architect.

In response to the user adjusting the values of the parameter via the interface elements, the system can pass the parameter values to the functional code. The functional code can then be executed using the adjusted parameter values. The system can generate an updated output such as a modified version of the input image based on the parameter values. In an example embodiment, the output image and the user interface can be displayed concurrently via a common user interface that allows real-time control of the user interface elements and viewing of the generated responses.

In another example, the sequence processing model can modify or generate other content such as video, audio, and text. By way of example, the system can parse a user's intent in association with a content item including text data and generate a user interface element for controlling modifications to the text by a large language model. For instance, a user may submit a query including a request to make text content “more professional.” In response, the system can generate functional code for controlling an LLM to alter the tone of the text content. The system can generate user interface elements corresponding to controllable parameters of the functional code for interacting with the LLM. By way of example, the system can generate an interface element such as a slider or control knob to control the amount of modification of the tone of the text. Additionally, the system can generate user interface elements including suggestions or additive parameters such as to make the text more readable, casual, etc. or to control the target audience for whom the text is written.

In accordance with an example implementation of the disclosed technology, the machine-learning generative user interface system can be configured to access one or more toolboxes. The toolboxes can include external code accessible by the generative user interface system. The toolboxes can be accessed using one or more application programming interfaces (APIs). By way of example, the toolboxes can include a large-language-model configured for text-style-transfer (e.g., style/tone adjustment), a general LLM configured for arbitrary prompt-based text transformation, a set of GPU filters (e.g., realtime image filters including blur, color adjust, etc.), a text-to-image generative model (e.g., prompt-based image adjustments), a multimodal model, or other external functional code.

In an example embodiment, the APIs for the tools available to the user interface system can be provided to a sequence processing model of the system in a prompt. For instance, the user query, the content item, and data describing the APIs for the external toolboxes can be provided in a prompt to a large language model of the generative UI system. The LLM can then generate functional code that includes calls or other references to the external toolboxes using the API information. The LLM can utilize a parameter API to call a function to get a parameter. This enables the LLM to add a parameter at any point in the functional code. The API can record the parameter type so that the system can generate a UI element for the parameter.

According to an example aspect of the present disclosure, a data store can be configured to store functional code and/or interface code generated in response to user queries. By storing previously-generated code, the system can provide a cascading or amplifying impact of the generated tools. For instance, code can be generated, re-used, and/or shared with others to scale and provide additional impact.

According to an example aspect of the present disclosure, the system can package the functional code and interface code (e.g., selected UI elements) into a package for ease of use and transport of the generated functionality. For example, the code and UI components can be packaged into a GUI panel that can be dragged and dropped or otherwise moved or copied. The GUI panel can be controlled by a user to be placed elsewhere for convenience or condensed into a simple UI element (e.g., single button) so that functionality persists and can be used at a later point in time.

Systems and methods in accordance with example embodiments of the present disclosure provide a number of technical effects and benefits. In particular, the systems and methods can include technologies that surface user interface elements that enable user control of machine-learned models when generating content. The systems and methods include a generative user interface system that is configured to generate functional code and interface code in response to a user query associated with a content item. The system can leverage a sequence processing model to generate functional code that is responsive to the user query for manipulating the content item. The sequence processing model can further generate interface code that enables a user to control parameters of a generative model when manipulating the content item. The system can identify one or more target system actions associated with the content item and generate a user interface element that enables user control of a functional code parameter associated with the target system action. In this manner, the system can automatically generate a user interface that enables a user to explore and traverse the vast array of outcomes that the generative model is able to create in response to the user query.

Traditional interactions with generative machine-learned models have been facilitated by user generated prompts that are provided as inputs to the models. In response to a prompt, the system generates an output such as generative content including images, text, audio, etc. To revise the output, a user can submit a new prompt and receive a new output. The size of these generative models requires large amounts of computing resources to process user queries. As such, these traditional approaches, in some instances, can lead to large consumptions of computing resources as the models are queried repeatedly until a user receives a satisfactory result. Systems and methods in accordance with example embodiments of the present disclosure automatically generate functional code that can interact with a generative model and interface code that surfaces the array of diverse outcomes that are available from the generative model when processing a content item. The interface code provides finer-grained control of the generative model to enable a user to more intelligently query the generative model for an output. The one-shot, repetitive nature of traditional interfaces can be avoided, leading in some examples to fewer queries to the generative model and more expressive capabilities when queries are made.

With reference now to the Figures, example embodiments of the present disclosure will be discussed in further detail.

### Example System Arrangements

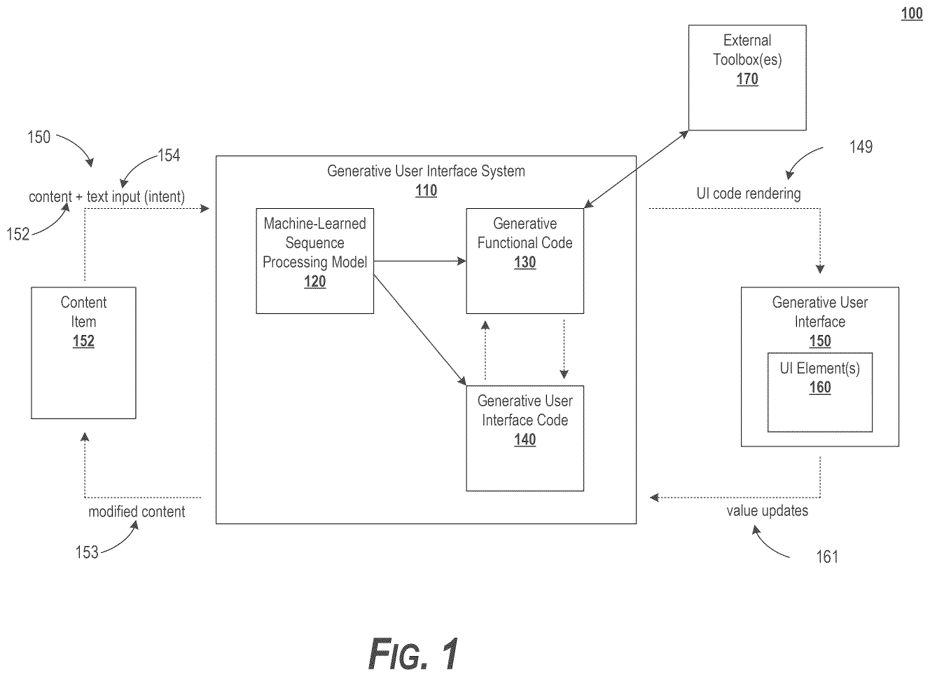

FIG. 1 is a block diagram depicting an example computing environment 100 including a machine-learned generative user interface system according to an example embodiment of the present disclosure. Computing environment 100 includes a machine-learned generative user interface system 110 that includes one or more machine-learned sequence processing models 120 that are configured to respond to user queries by generating computer-executable functional code and user interface code. An example is depicted in FIG. 1 where a user query 150 is received in association with a content item. User Query 150 is one example of an input indicative of a user intent. The content item may form part of the user query or be referenced by the user query for example. In FIG. 1, the user query includes the content item 152 as a first query component and a text input 154 as a second query component. The text input 154 can represent a context associated with the second query component. In other examples, a context associated with a query component such as an image can be determined in other manners than a text input. Generative user interface system 110 processes the user query 150 to generate modified content 153 for content item 152. Modified content 153 can include a new content item that is a modified version of the original content item 152. Generative user interface system 110 produces or writes generative functional code 130 and generative user interface code 140 in response to the user query. A generative user interface 150 can be rendered using the interface code 140 to enable user control of the generation of modified content 153 by the generative user interface system 110.

Generative user interface system 110 can include one or more machine-learned sequence processing models 120 such as a large language model (LLM) that is configured to process a user query 150 for the generation of one or more generative outputs such as modified content 153. Content item 152 can include text data, audio data, image data, video data, latent encoding data (i.e., a multi-dimensional encoding of content), or any other data representative of content capable of processing by a machine-learned model. Interface system 110 can formulate one or more prompts to be provided to model 120 based on the user query. For example, a prompt can be constructed that includes the content item 152 and the text input 154.

In response to the user query 150, the sequence processing model 120 can generate computer-executable functional code 130 that facilitates processing of the content item 152 based on the text input 154. In some examples, functional code 130 can include one or more calls to one or more external toolboxes 170 such as a machine-learned generative model that is configured to process queries and generate content (e.g., by modifying an image).

Sequence processing model 120 can also generate computer-executable interface code 140 for a user interface 160 that includes one or more user interface elements 162 for controlling the functional code 130. For example, the user interface 160 can include a user interface element 162 to control a parameter in the functional code that is associated with the user interface element 162. The user interface element can be mapped to the parameter in the functional code. The user interface system 110 can receive value updates 161 for the corresponding parameter of the functional code. In response to user input provided to a UI element, the user interface system can receive value updates 161, execute functional code 130 using the value updates to the parameters, and provide a modified content item 152.

In some examples, machine-learned generative system 110 may be implemented by a first computing system and the user queries can be received via other computing systems such as user computing devices or other remote computing systems. For instance, computing environment 100 may be implemented as a client server computing environment, including one or more client computing devices that provide queries and render generative user interface 160 and one or more server computing devices that implement generative user interface system 110. Generative user interface system 110 can be implemented as a stand-alone system and/or can be implemented with or otherwise as part of a cloud data storage service, an email service, a videoconference service, or other hosted service that utilizes the generative user interface system 110. For instance, a hosted data storage service system can implement one or more hosted applications that provide services and/or access to data stored by the service system. In this manner, the generative system can be integrated with applications such as workspace applications including email applications, image or photo applications, social media applications, word processing applications, slide presentation applications, and other applications.

The computing systems implementing generative user interface system 110 and downstream applications can be connected by and communicate through one or more networks 180. Any number of user computing devices and/or server computing devices can be included in the client-server environment and communicate over a network. The network can be any type of communications network, such as a local area network (e.g., intranet), wide area network (e.g., Internet), or some combination thereof. In general, communication between the computing devices can be carried via a network interface using any type of wired and/or wireless connection, using a variety of communication protocols (e.g., TCP/IP, HTTP, RTP, RTCP, etc.), encodings or formats (e.g., HTML, XML, etc.), and/or protection schemes (e.g., VPN, secure HTTP, SSL, etc.).

In some example embodiments, a user computing device implementing a downstream application can be any suitable device, including, but not limited to, a smartphone, a tablet, a laptop, a desktop computer, or any other computer device that is configured such that it can allow a user to access remote computing devices over a network. The user computing devices can include one or more processor(s), memory, and a display as described in more detail hereinafter. The user computing devices can execute one or more client applications such as a web browser, email application, chat application, video conferencing application, word processing application or the like.

It will be appreciated that the term “system” can refer to specialized hardware, computer logic that executes on a more general processor, or some combination thereof. Thus, a system can be implemented in hardware, application specific circuits, firmware, and/or software controlling a general-purpose processor. In one embodiment, the systems can be implemented as program code files stored on a storage device, loaded into memory and executed by a processor or can be provided from computer program products, for example computer executable instructions, that are stored in a tangible computer-readable storage medium such as RAM, hard disk, or optical or magnetic media.

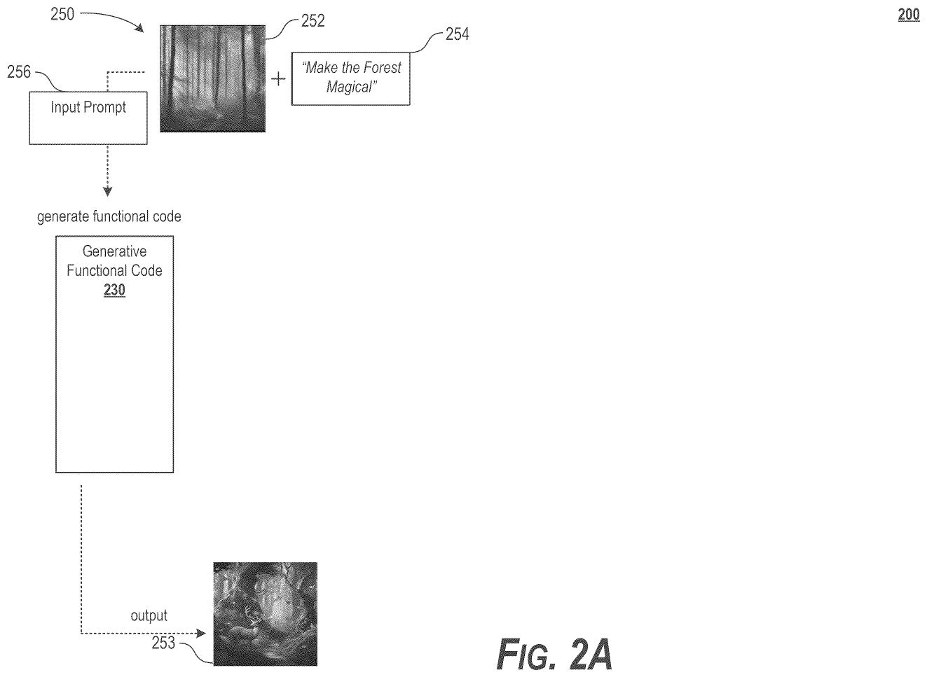

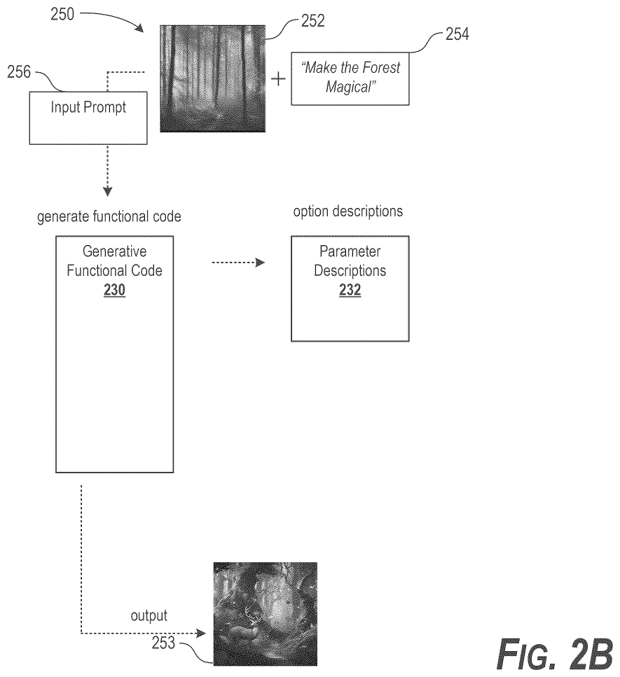

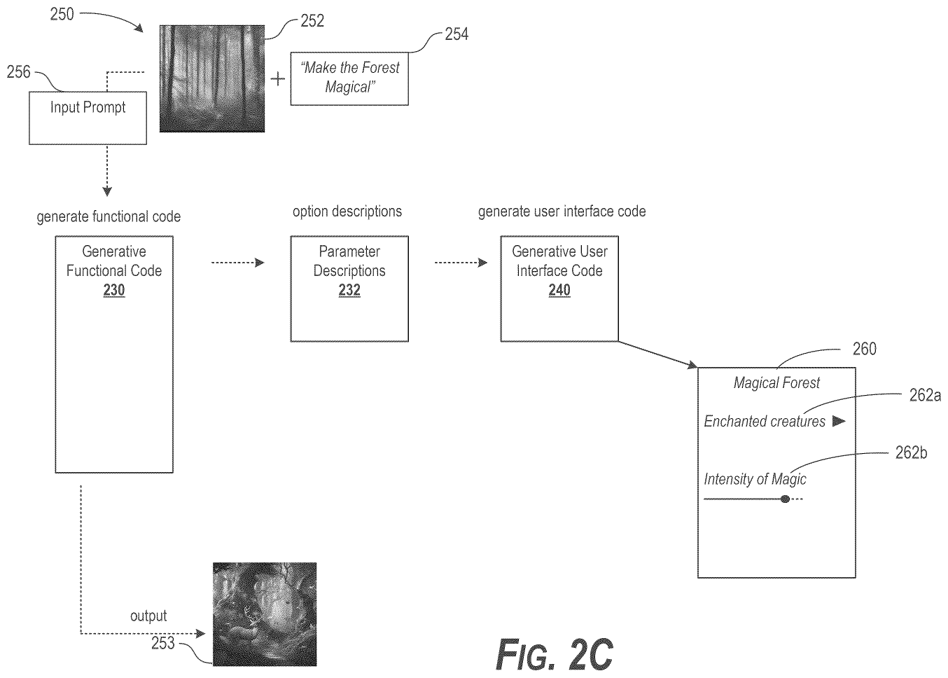

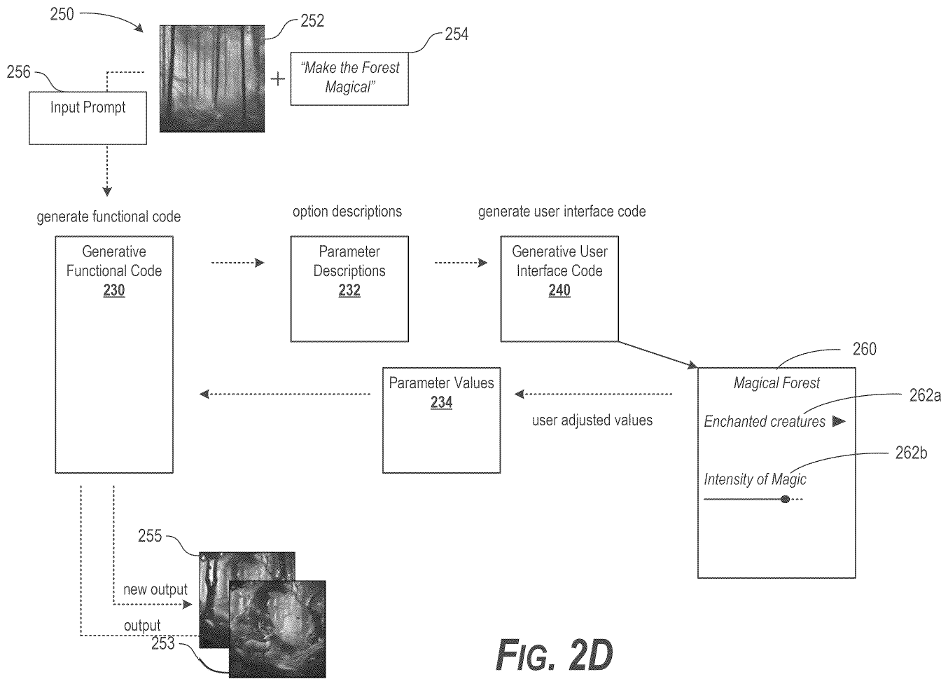

FIGS. 2A-2D are block diagrams depicting an example computing environment 200 and a data flow for generating computer-executable functional code and interface code according to example embodiments of the present disclosure. Referring to FIG. 2A, computing environment 200 depicts an example of processing a user query that requests manipulation of an image content item. Specifically, a user query 250 is received that includes an input image 252 component and a text input 254 component. The text input 254 component requests with respect to input image 252 that the generative user interface system “make the forest magical.” The generative user interface system formulates an input prompt 256 including the input image 252 and text input 254. In an example, the system can include a prompt editor that allows users to formulate and submit users queries such as prompts. The prompt editor can include an interface for receiving text inputs, image inputs, video inputs, or any other type of data. By way of example, a user can reference a content item and provide a text input to generate a prompt, such as “enhance colors,” “add rain clouds,” or any other request for processing by the system. In example embodiments, the prompt may be supplemented by the generative UI system. For example, the prompt may include instructions to the model to generate functional code for responding to the user query and interface code for controlling one or more parameters of the functional code. In example embodiments, the generative user interface system can include a prompt library containing prompt templates. A prompt template can be populated with data from a user query to generate an input prompt for the sequence processing model.

The generative user interface system can respond to the input prompt requesting “make the forest magical” with respect to the input image by generating functionality associated with the user query. The system can determine one or more target system actions associated with the text query. The target system actions may represent one or more user intents associated with the text query. The system can submit the prompt to a machine-learned sequence processing model (e.g., an LLM) of the generative system. In some examples, input prompt 256 can include a request or instruction for the LLM to generate functional code in response to the input prompt. The input prompt 256 can include information describing one or more external toolboxes that are available to the user interface system. For example, the input prompt can include API data for one or more machine-learned generative models accessible to the generative user interface system.

The LLM creates generative functional code 230 in response to the input prompt. The functional code can include one or more calls to an external toolbox such as external code for a machine-learned generative model. Additionally, the generative UI system can execute the functional code 230 to generate an output in response to the input prompt 256. In this example, the generative output is an image 253 which is a modified content item including a depiction of a magical forest including magical creatures. In an example embodiment, the functional code 230 can call one or more generative models such as a text-to-image model to perform the image modification.

With reference now to FIG. 2B, the user interface system additionally generates one or more parameter descriptions 232 corresponding to one or more parameters in the functional code. The parameter descriptions 232 can be defined by the functional code 230 and can include option descriptions corresponding to the functional code. Each parameter description can define an option for controlling a different aspect of behavior of the functional code. Each parameter description can include metadata such as labels and ranges to control the corresponding aspect of code behavior. By way of example, the system may generate functional code that includes “enhanced creatures,” and “intensity of magic,” parameters for modifying the input image to have a magical forest. Additional or alternative parameters can be generated such as “brightness,” “contrast,” and “gamma,” for example, in response to an input prompt to enhance the colors of the image. The LLM can generate parameter descriptions for each parameter. The descriptions can include labels (e.g., “enhanced creatures”) and metadata such as a “type” of the parameter and a range of values for the parameter. In this example, UI 260 can include a UI element 262a that enables a user to select a type of content to add such as “enchanted creatures,” “fairy lights,” etc. UI 260 can include a UI element 262b that enables a user to control the intensity of the magic added to the input image.

Referring now to FIG. 2C, the user interface system can generate user interface code 240 for a user interface that is configured to receive user inputs for controlling the parameter options. In some examples, a second input prompt can be generated by the user interface system and provided to the LLM to generate the interface code. The second input prompt can include the functional code and a request or instruction to generate interface code for a user interface that can control the parameters of the functional code. In another example, a single input prompt can be provided to the LLM to generate both the functional code and the user interface code.

Generative user interface code 240 can include code for rendering a user interface 260 at a client or other device for controlling the generative user interface system 210. Specifically, interface code 240 defines user interface elements 262 including a user interface element 262a that enables a user to select a type of content to add such as “enchanted creatures,” “fairy lights,” etc. for controlling a “brightness” parameter of the functional code. UI 260 can include a UI element 262b that enables a user to control the intensity of the magic added to the input image. UI element 262a includes a drop down menu that is generated to allow the user to control the type of content added to the image, such as “enchanted creatures,” etc. UI element 262b includes a “slider” user interface elements that enable a user to “slide” the user interface element to set a parameter value for the intensity of magic parameter. It will be appreciated that the system can generate other types of user interface elements based on the parameter being controlled. In another example, selectable “chip” user interface elements can be provided to allow a user to select particular options.

FIG. 2D depicts the computing environment and a response to a user interacting with user interface 250. A user provides one or more inputs to adjust the slider interface elements and/or the drop down menu corresponding to one or more of the “enhanced creatures,” or “intensity of magic” parameters of the functional code. The user interface system receives the updated parameter values 234 from the user interface code. The updated parameter values are passed to the functional code 230 to update the parameters in the functional code. After updating the functional code, the user interface system can execute the functional code to generate a new output 255. The new output 255 includes an image which is a generative output with the colors of the input image enhanced using the updated parameter values 234. For example, functional code 230 can call a text-to-image or other machine-learned model to generate an output image using the updated parameter values 234. In some examples, the system can pre-fetch outputs of the generative model based on the possible parameter values and provide a corresponding image in response to user input. In other examples, the system can fetch an output of the model using updated parameter values as they are input by a user.

In some examples, the system can parse a user's intent to find any aspects that can be parameterized. The system can also generate suggestions for things not directly tied to the user's explicit intent. For example, in response to a user intent to “make the forest more magical,” the system can generate additive suggestions such as “add magical creatures.” The system can generate suggestions for additional or alternate routes to take. For example, the system can generate suggestions to make the forest “more spooky,” or “more sci-fi,” etc.

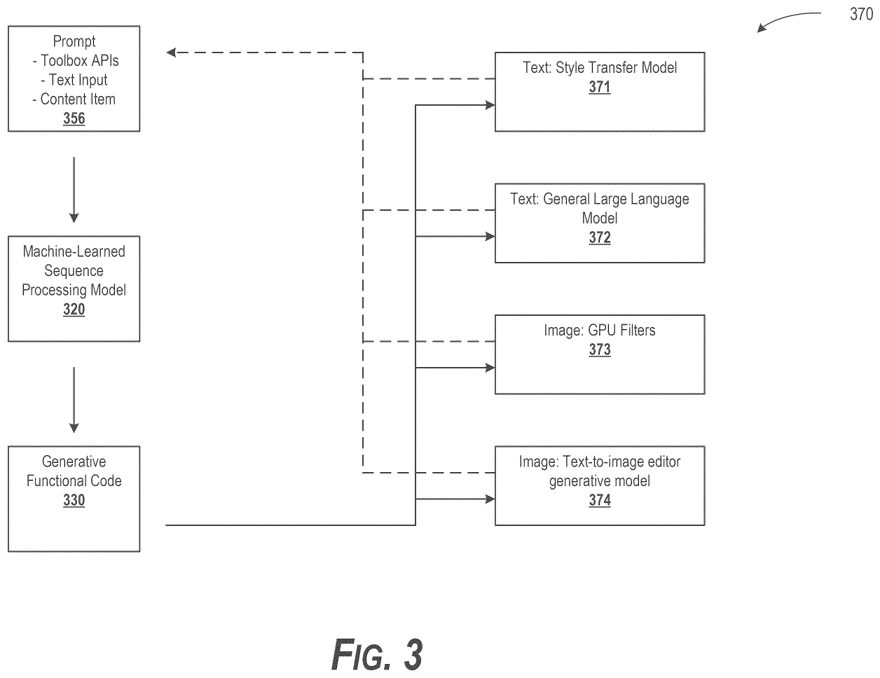

FIG. 3 is a block diagram depicting an example computing environment including a machine-learned sequence processing model configured to process prompts including API descriptions for external toolboxes according to example embodiments of the present disclosure. FIG. 3 depicts an example machine-learned sequence processing model 320 in accordance with example embodiments of the present disclosure. Sequence processing model 320 is one example of machine-learned sequence processing model 120 depicted in FIG. 1. The machine-learned generative user interface system can be configured to generate functional code that accesses one or more external toolboxes 370. FIG. 3 depicts an example set of four external toolboxes. It is noted that the number and type of external toolboxes is depicted by way of example only.

Toolboxes 370 can include a first toolbox 370a that includes an external machine-learned style transfer model. The style transfer model can include an LLM that is configured to perform style and/or tone adjustments to content items that include text. A second toolbox 370b can include a general LLM configured for arbitrary prompt-based text transformation. A third toolbox 370c can include a set of GPU filters (e.g., realtime image filters including blur, color adjust, etc.). A fourth toolbox 370d can include a text-to-image generative model (e.g., prompt-based image adjustments). The set of toolboxes 370 is presented by way of example only. The system may include any number and type of toolboxes 370. Other toolboxes can be included in example implementations including any type of machine-learned generative model.

Generative models can include any type of machine-learned generative model. In an example, a generative model can include a sequence processing model, such as a large language model including 10B parameters or more. In another example, a generative model can include a language model having less than 10B parameters (e.g., 1B parameters). In yet another example, the generative model can include an autoregressive language model or an image diffusion model. As further examples, a generative model can include a machine-learned text-to-image model, a machine-learned text-to-video model, a machine-learned text-to-audio model, a machine-learned multi-modal model, or any other machine-learned model configured to provide generative content in response to a user query. The generative content generated by generative models can include computer-executable code data, text data, image data, video data, audio data, or other types of generative content. The generative model can be trained to process input data to generate output data. The input data can include text data, image data, audio data, latent encoding data, and/or other input data, which may include multimodal data. The output data can include computer-executable code data, text data, image data, audio data, latent encoding data, and/or other input data. It is noted that machine-learned sequence processing model 320 can also be called by functional code 330 as a toolbox available to the system.

Each toolbox 370 can include external code that is accessible by functional code generated by the generative user interface system. The toolboxes can be accessed using one or more application programming interfaces (APIs) associated with each toolbox. The generative user interface system can access or otherwise obtain data describing an API for a particular toolbox. Data describing the API for each toolbox available to sequence processing model 320 can be provided as an input to model 320. For example, the APIs for the toolboxes 370 can be listed in a prompt to sequence processing model 320. The APIs can be supplied as arguments to the prompt function in example embodiments. In an example implementation, the text component, the content item, and data describing the APIs for the external toolboxes can be provided in a prompt to model 320. Model 320 can then generate functional code 330 that includes calls or other references to the external toolboxes using the API information.

In an example implementation, the user interface system can be configured to do parameterization during the generation of functional code 330 using a parameter API. At any point in the functional code, model 320 can call the parameter API function to get a parameter. The function can record the parameter type to enable the system to create a user interface element for the parameter. In this manner the user interface system can add a parameter at any point during the code execution.

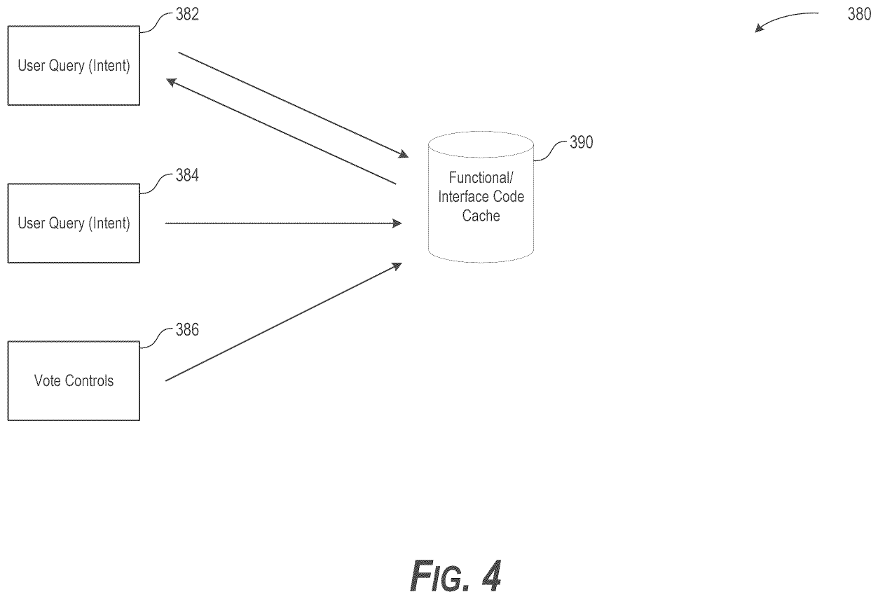

FIG. 4 is a block diagram depicting an example computing environment 380 including a data store 390 configured to store functional code and/or interface code generated in response to user queries. By storing previously-generated code, the system can provide a cascading or amplifying impact of the generated tools. For instance, code can be generated, re-used, and/or shared with others to scale and provide additional impact. In the example of FIG. 4, a user query 382 expressing a particular intent with respect to content generation and/or modification can be received. The system can first check in data store 390 to determine if the same user query or intent is stored in the data store. If the particular user intent has been processed before and stored, the system can obtain the pre-generated functional code and/or interface code for the user query. The pre-generated code from the datastore can be used to generate a user interface for query 382. If the user intent is not stored in data store 390, the system can generate the functional and/or interface code as shown at 384. Once the code is generated, the system can store it for use to respond to subsequently received queries. FIG. 4 also demonstrates that a user can utilize vote controls 386 to provide an indication to up or downvote code in the data store. If a user upvotes a tool, it can be used as a default for that user. Otherwise, the system can use the top result as ordered by votes. If an object's store is negative, the system can delete it.

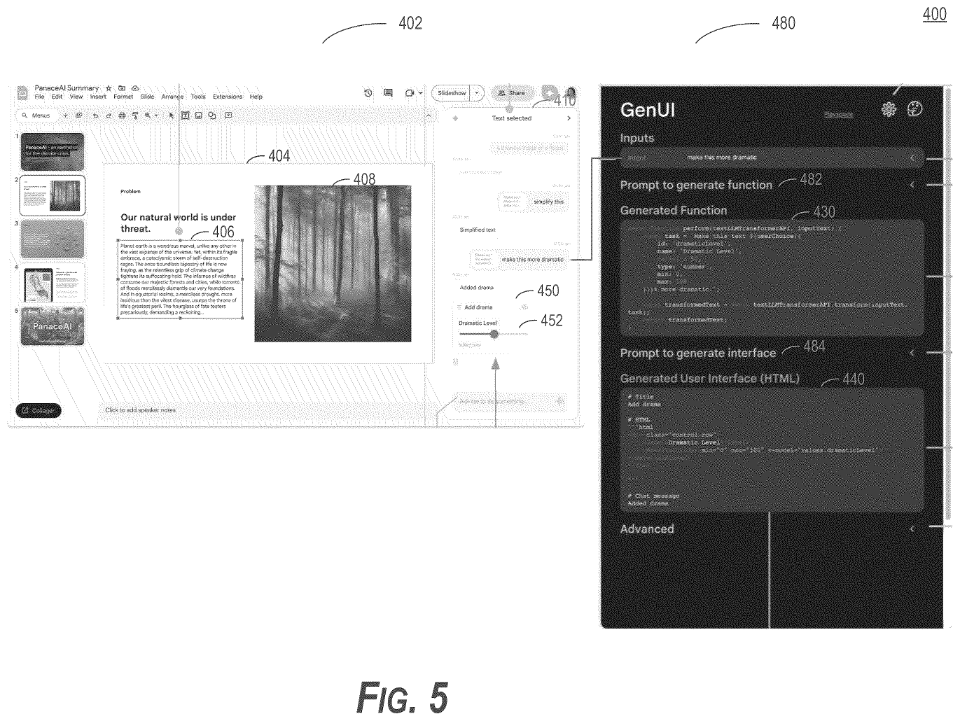

FIG. 5 is a graphical depiction of a computing environment 400 including an interface of a generative user interface system according to an example implementation of the disclosed technology. FIG. 5 depicts an example of the integration of a generative user interface system with a workspace application. Specifically, FIG. 5 depicts a graphical user interface (GUI) 402 of a workspace application that enables a user to create and edit presentation slides. The workspace application includes a chatbot interface 410 that enables a user to access one or more machine-learned models to generate, edit, or otherwise manipulate content for a slide. FIG. 5 also depicts a generative UI system interface 480 that facilitates user interaction with the generative UI system. It will be appreciated that the slides application is provided by way of example only. A similar interface and integration with a generative UI system can be implemented with applications such as email applications, word processing applications, web browsing applications, or any other application associated with presenting and/or editing content.

The workspace application interface 402 depicts a first “slide” 404 including text 406 and an image 408. In FIG. 5, the system receives a user selection of text 406, such as by receiving input from a mouse or touchscreen interface that indicates selection of the text. Chatbot interface 410 is depicted adjacent to the slide interface and enables a user to access a chatbot which may be implemented using one or more machine-learned generative models (e.g., an LLM). An example history of interactions with the chatbot is shown in FIG. 4. For example, the chatbot history illustrates a user query “a dreamy image of a forest.” In response to this user query, the chatbot generates image 408 and provides a chat notification that it “generated image.” The chatbot may call an external toolbox such as a text-to-image model to generate the image. The history also includes a user query instructing the chatbot to “simply this,” received in combination with the selection of text 406. In response, the chatbot generates a simplified form of text 406. The chatbot may call an external toolbox such as an LLM to generate a simplified form of text 406.

Next, with the text selected, the system receives a user query via chatbot interface 410 instructing the system to “make this more dramatic.” In this instance, the system receives the user query including the text input “make this more dramatic” in association with a content item, text 406. In response to the user query, the user interface system generates functional code 430 to cause rewriting of text 406 to be more dramatic. The functional code 430 is displayed in the generative UI system interface 480. Specifically, text 406 and image 408 are formulated into a prompt 482 to generate the functional code. Functional code 430 includes an API call to an external toolbox such as an external LLM configured for text transformation. The functional code includes a parameter, “dramaticLevel,” and metadata and labels for the parameter. The parameter is defined with a number type and a range of possible values (e.g., 0-100) that control the level to which the transformation makes the text more dramatic.

Generative UI system interface 480 displays a prompt 484 to generate interface code corresponding to functional code 430. In response to prompt 484, the generative UI system generates interface code 440. Interface code can be executed to render generative UI interface 450. Generative UI interface 450 includes a UI element 452 corresponding to the “dramaticLevel” parameter in the functional code. UI element 452 is rendered as a slider element. User manipulation of the slider can control the value of the “dramaticLevel” parameter of the functional code. In response to updated parameter values for the “dramaticLevel” parameter, the system can execute the functional code 430 with the updated parameter values. For example, the system can call the external LLM using the updated parameter values to generate a new image 408.

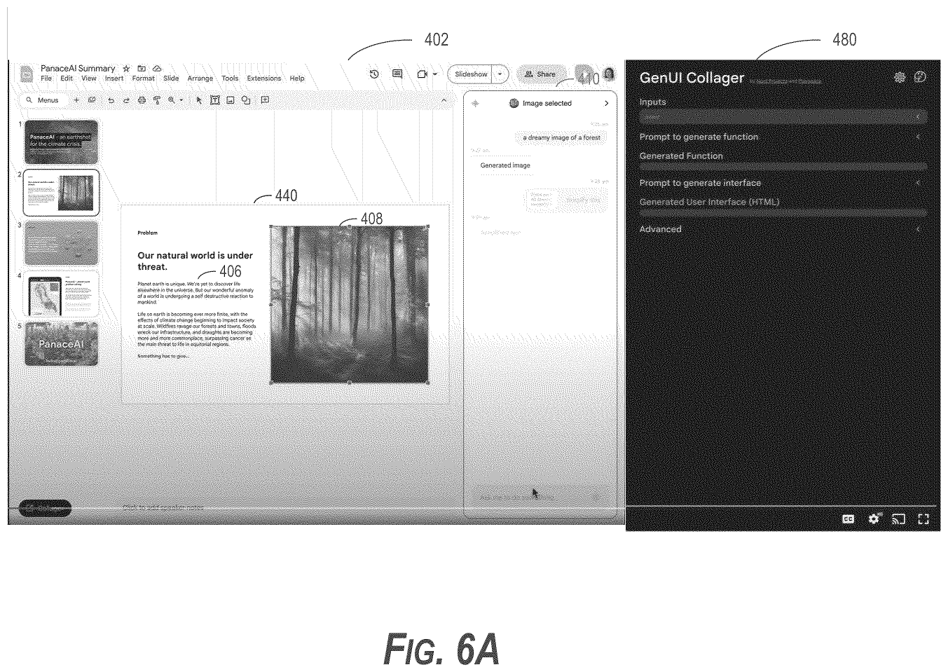

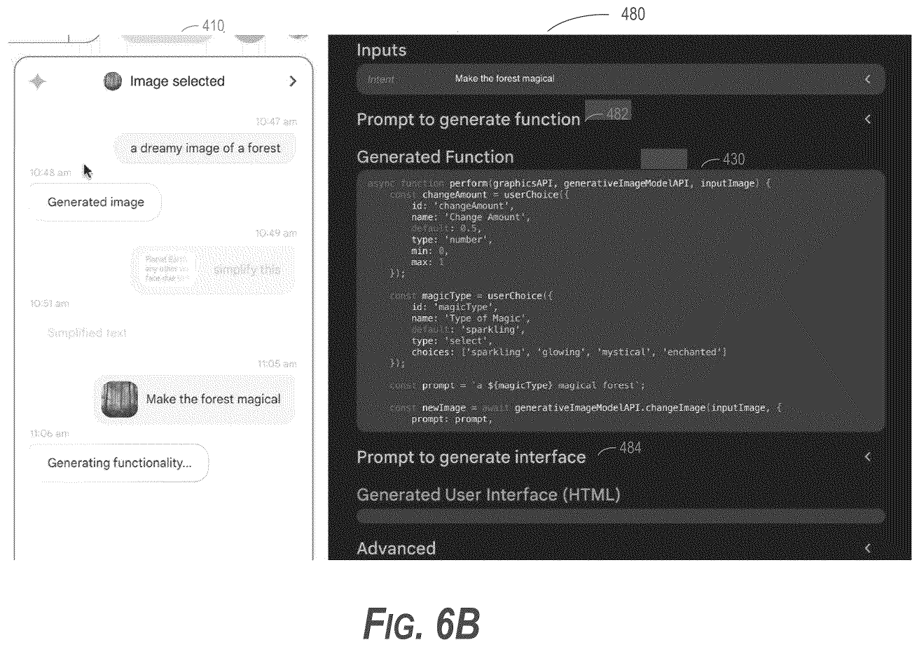

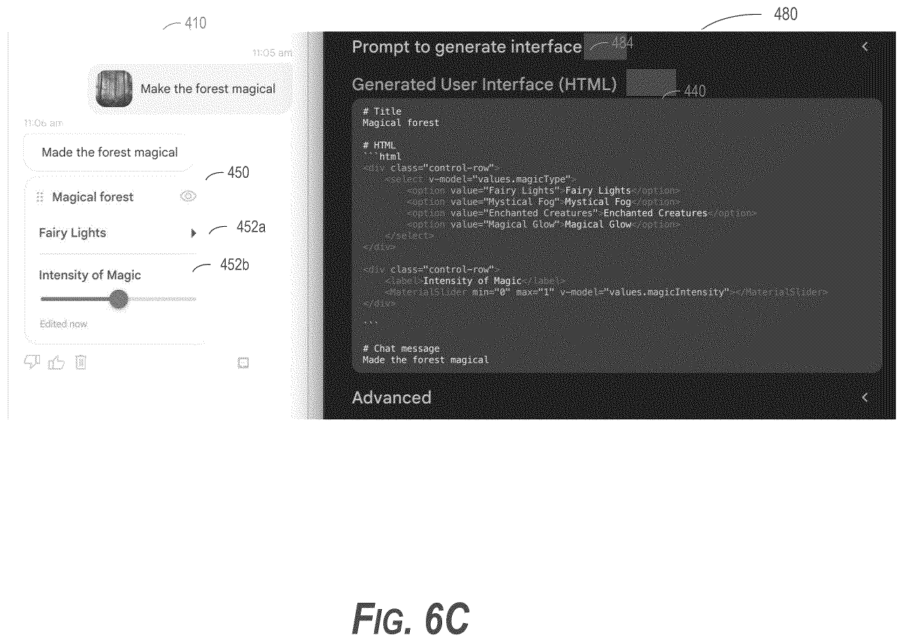

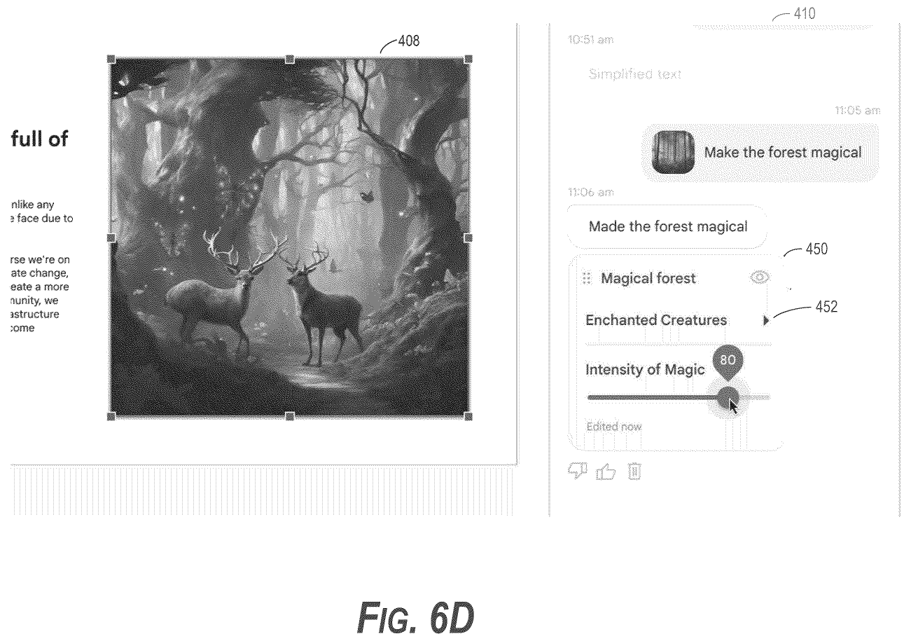

FIGS. 6A-6D are graphical depictions of computing environment 400 and an example of processing a user interaction with a generative user interface system according to an example implementation of the disclosed technology. FIG. 6A depicts the graphical user interface (GUI) 402 as shown in FIG. 5. In this example, after the history of chatbot interactions, the system receives a user selection of the image 408 and a user query “make the forest magical” as shown in FIG. 6B. FIG. 6B is a zoomed in view of the interface, illustrating details of chatbot interface 410 and generative UI system interface 480.

The system receives a user query (via chatbot interface 410) including a request for the system to “make the forest magical” in association with the image 408 content item. In response to the user query, the user interface system generates functional code 431 to cause editing of image 408 by o make it appear more “magical.”. The functional code 430 is displayed in the generative UI system interface 480. Specifically, the text component of the user query and the image 408 are formulated into a prompt 482 to generate the functional code 430. Functional code 430 includes an API call to an external LLM capable of image generation. The functional code includes a parameter, “changeAmount,” and metadata and labels for the parameter. The parameter is defined with a number type and a range of possible values (e.g., 0-1) that control the amount of ferns added to the forest floor. The functional code includes a parameter, “magicType,” and metadata and labels for the parameter. The parameter is defined with a “select” type and choices “sparkling,” “glowing,” “mystical,” and “enchanted.”

Generative UI system interface 480 displays a prompt 484 to generate interface code corresponding to functional code. In response to prompt 484, the generative UI system generates interface code 440 as shown in FIG. 6C. Interface code is executed to render generative UI interface 450. Generative UI interface 450 includes a UI element 452a corresponding to the “MagicType” parameter in the functional code. UI element 452 is rendered as a drop down menu element. User manipulation of the menu can control the value of the “MagicType” parameter of the functional code. In response to updated parameter values for the “MagicType” parameter, the system can execute the functional code 430 with the updated parameter values. For example, the system can call the external LLM using the updated parameter values to generate a new image 408. Similarly, generative UI interface includes a UI element 452b corresponding to the “changeAmount” parameter in the functional code. FIG. 6D depicts updated image 408 after receiving updated parameter values.

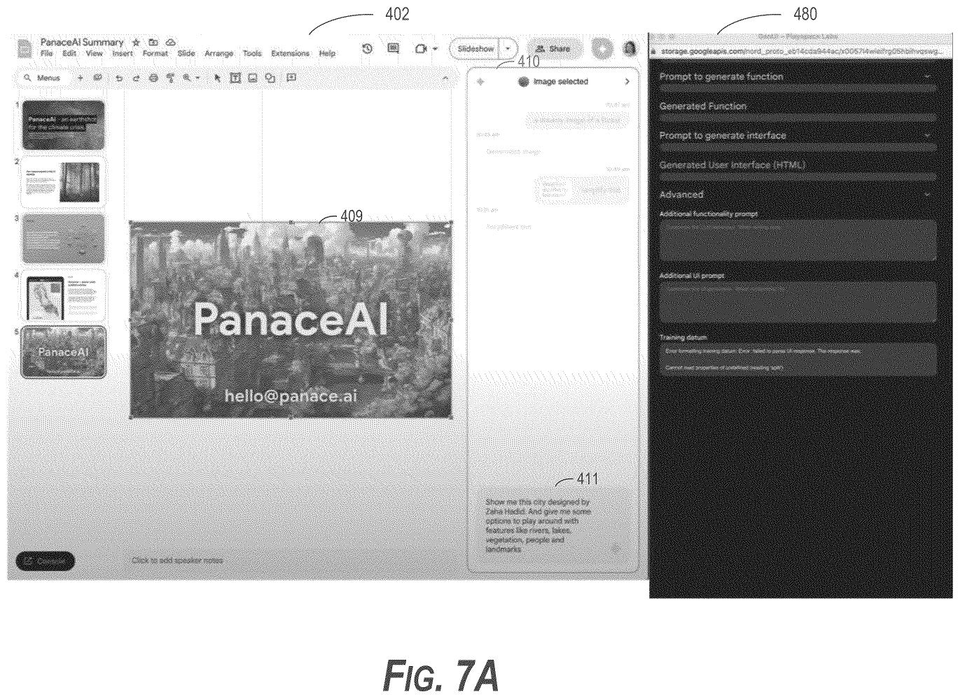

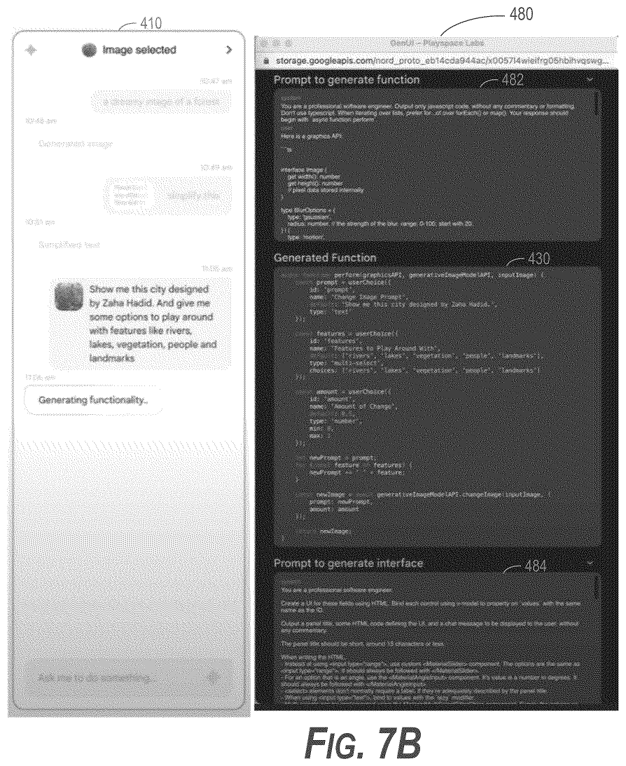

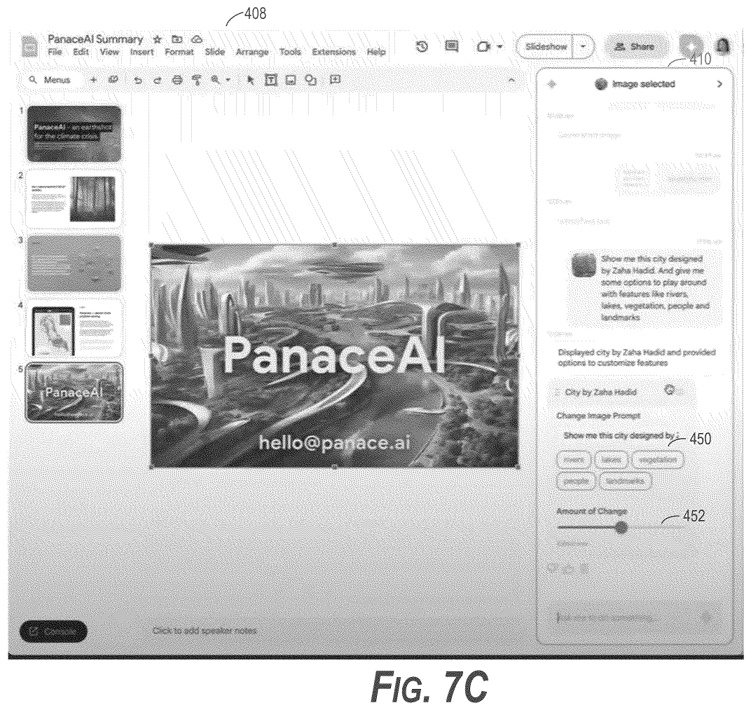

FIGS. 7A-7C are graphical depictions of computing environment 400 and an example of processing a user interaction with a generative user interface system according to an example implementation of the disclosed technology. FIG. 7A depicts an example of graphical user interface (GUI) 402 as shown in FIG. 4. In this example, after the history of chatbot interactions, the system receives a user selection of image 409 and a user query 411 or other contextual input indicating “Show me this city designed by Zaha Hadid. And give me some options to play around with features like rivers, lakes, vegetation, people and landmarks” as shown in FIG. 7A. In response to the user query, the user interface system generates a prompt to generate functional code, and then generates functional code 430 to cause editing of image 409 as shown in FIG. 7B. In this case, the system determines the semantic meaning of the input query and generates functional code that enables a user to control an “amount” or “degree” by which the image is edited to appear designed by Zaha Hadid. Accordingly, the system is capable of generating UI elements and parameters for controlling any input content to provide semantic editing capabilities. In this case, the system understand that the input context is to modify the image to appear as if produced by a particular architect. The functional code can also enable the user to control the presence of features like rivers, lakes, vegetation, people and landmarks. The prompt and functional code 430 is displayed in the generative UI system interface 480. Specifically, the text component of the user query and the image 409 are formulated into a prompt 482 to generate the functional code 430. Functional code 430 includes an API call to an external model capable of image generation and editing.

Generative UI system interface 480 displays a prompt 484 to generate interface code corresponding to functional code. Interface code is executed to render generative UI interface 450 as shown in FIG. 7C. Generative UI interface includes a UI element 452 corresponding to an amount of “change” parameter in the functional code. UI element 452 is rendered as a slider element. User manipulation of the slider can control the value of the “change” parameter of the functional code. The change parameter can affect the amount by which image 409 is manipulated to appear in accordance with the selected architect. UI interface 450 additionally includes UI elements such as selection chips that allow the user to provide input indicating whether or not to include features such as “rivers,” “lakes,” “vegetation,” “people,” and “landmarks.” In response to updated parameter values for the parameters, the system can execute the functional code 430 with the updated parameter values. For example, the system can call the external LLM using the updated parameter values to generate a new image 409.

### Example Methods

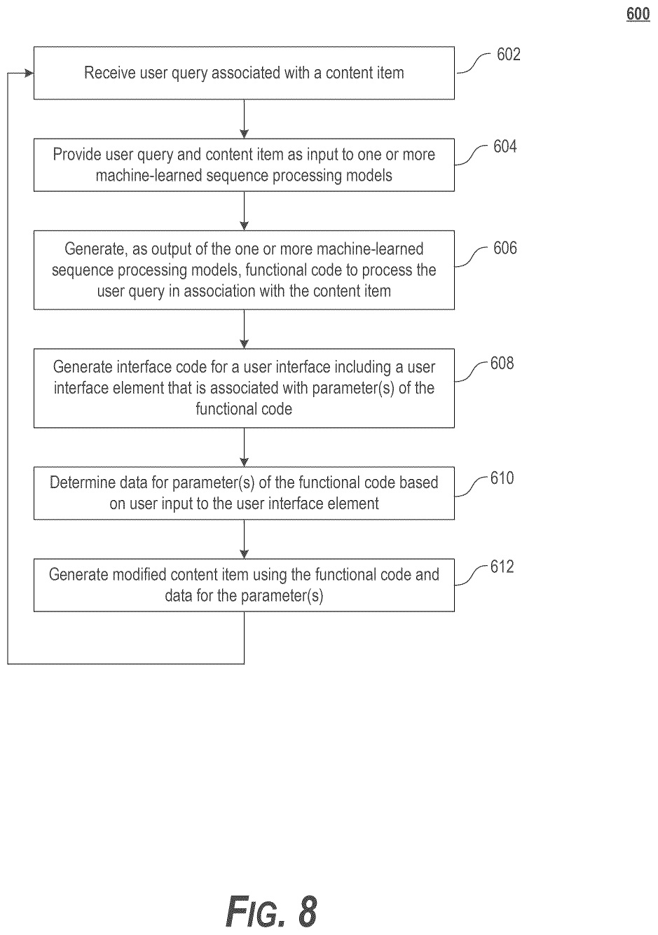

FIG. 8 is a flowchart diagram depicting an example method 600 of processing a user query by generating functional code and user interface code that facilitate user control of one or more machine-learned generative models. One or more portion(s) of example method 600 and the other methods described herein can be implemented by a computing system that includes one or more computing devices, such as, for example, computing systems described herein. By way of example, one or more portions of example method 600 can be performed by a generative user interface system 110 including one more machine-learned sequence processing models configured to generate functional and interface code, and one or more machine-learned generative models configured to generate content in response to user queries. Each respective portion of the example methods can be performed by any (or any combination) of one or more computing devices. Moreover, one or more portion(s) of the example method 600 can be implemented on the hardware components of the device(s) described herein, for example, to generate content using one or more machine-learned generative models. The methods in the figures may depict elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. The example methods are described with reference to elements/terms described with respect to other systems and figures for exemplary illustrated purposes and are not meant to be limiting. One or more portions of the example methods can be performed additionally, or alternatively, by other systems.

At 602, method 600 can include receiving a user query including or otherwise associated with a content item. The user query can include a text component expressing one or more target system actions with respect to the content item. The content item can include text content, audio content, image content, video content, or any other content capable of processing by a machine-learned model. The text component can include a text query associated with the content item. The text query can express one or more target system actions for processing the content item by a machine-learned generative model.

At 604, method 600 can include providing the user query as one or more inputs to one or more machine-learned sequence processing models. The user query can be provided as one or more prompts to the sequence processing model(s) in example embodiments. The one or more prompts can also include data describing one or more toolboxes such as generative models accessible to the generative user interface system for processing content items. The one or more prompts can also include a request or instructions for the sequence processing model to generate functional code to fulfill the user query and interface code to facilitate user manipulation of one or more parameters of the functional code. In an example implementation, the user interface system can include a set of template prompts. In response to a user query, the system can modify a template prompt with the user query information to generate an input prompt for the sequence processing model.

At 606, method 600 can include generating functional code for processing the content item in accordance with the text input representing one or more target system actions. At 606, method 600 can include receiving one or more outputs from the sequence processing model(s) including executable functional code generated in response to the user query. The sequence processing model can determine the one or more target system actions from the text component of the user query and generate functional code the fulfills the target system actions. The model can also generate parameter descriptions for one or more parameters of the functional code. The one or more parameters can be generated to allow user control over processing to fulfill the intents.

At 608, method 600 can include generating interface code for a user interface including a user interface element that is configured to receive user inputs to define a value of one or more parameters of the functional code. The user interface element can be mapped to the parameter of the functional code in example implementations. In some examples, the sequence processing model can generate the interface code at 608. For instance, one or more prompts can be provided to the sequence processing model including a request to generate interface code for the functional code generated at 606. A single prompt can be issued to the sequence processing model to generate the functional code and the interface code in an example implementation. In other implementations, separate prompts can be issued to the sequence processing model to generate the functional code and the interface code. In some examples, a separate code generator can generate one or more portions of the interface code. For example, the sequence processing model can generate the substantive portions of the interface code and a heuristics engine can generate standard user interface code such as boilerplate hyper-text markup language (HTML) code.

At 610, method 600 can include determining data such as a value for a parameter of the functional code corresponding to the user interface element. At 610, the user interface rendered by the interface code may be used to determine the value for the parameter of the functional code. The user interface may receive one or more user inputs to the user interface element corresponding to the parameter. In response, the system can determine the value of the parameter based on the input to the user interface element. The value for the parameter can be passed to the functional code.

At 612, method 600 can include generating a modified content item using the functional code and the data for the parameter. The functional code can be executed using the value for the parameter determined from the input to the user interface. The parameter value can be passed to the functional code and the functional code executed. By way of example, the functional code can provide the parameter value in a call to an external machine-learned generative model. The generative model can generate a modified content item using the parameter value passed by the functional code. The modified content item can include a new content item, such as a new version of the original content item after processing based on the user inputs.

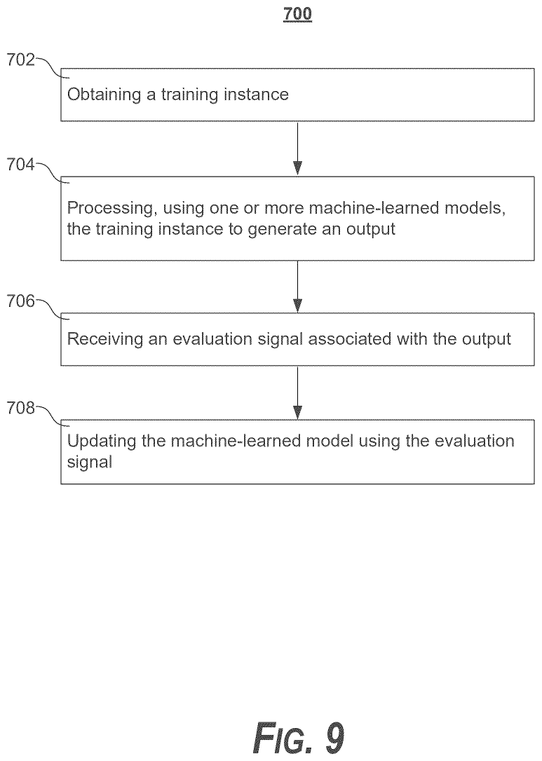

FIG. 9 depicts a flowchart of a method 700 for training one or more machine-learned models according to aspects of the present disclosure. For instance, an example machine-learned model can include a core sequence processing model, such as a foundational large language model (LLM).

At 702, example method 700 can include obtaining a training instance. A set of training data can include a plurality of training instances divided between multiple datasets (e.g., a training dataset, a validation dataset, or testing dataset). A training instance can be labeled or unlabeled. Although referred to in example method 700 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 704, example method 700 can include processing, using one or more machine-learned models, the training instance to generate an output. The output can be directly obtained from the one or more machine-learned models or can be a downstream result of a chain of processing operations that includes an output of the one or more machine-learned models.

At 706, example method 700 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 708, example method 700 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 600 can include implementing a number of generalization techniques (e.g., weight decays, dropouts, etc.) to improve the generalization capability of the models being trained.

In some implementations, example method 700 can be implemented for training a machine-learned model from an initialized state to a fully trained state (e.g., when the model exhibits a desired performance profile, such as based on accuracy, precision, recall, etc.).

In some implementations, example method 700 can be implemented for particular stages of a training procedure. For instance, in some implementations, example method 700 can be implemented for pre-training a machine-learned model. Pre-training can include, for instance, large-scale training over potentially noisy data to achieve a broad base of performance levels across a variety of tasks/data types. In some implementations, example method 700 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

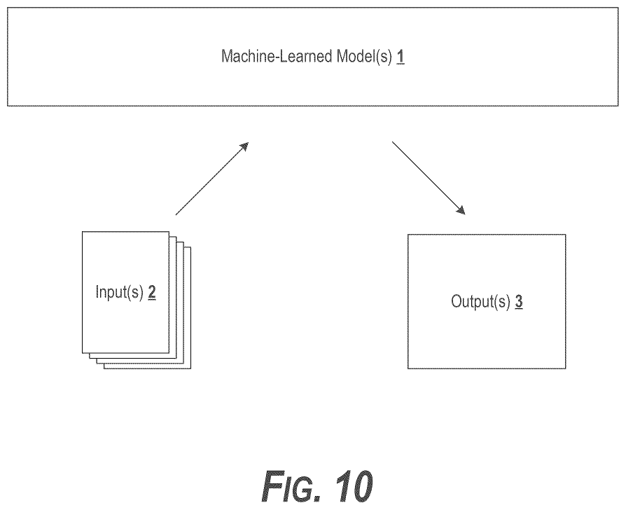

FIG. 10 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism, such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, arXiv: 2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

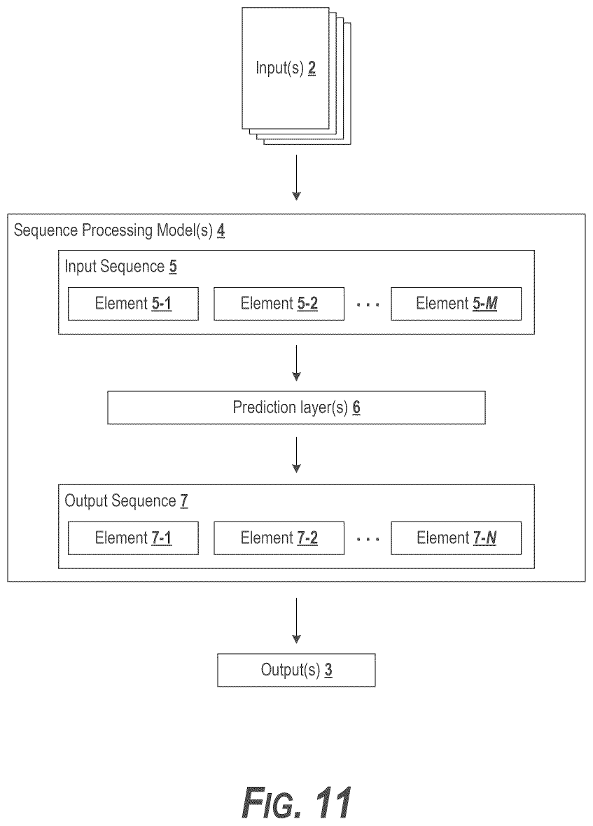

FIG. 11 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 7 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 6. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

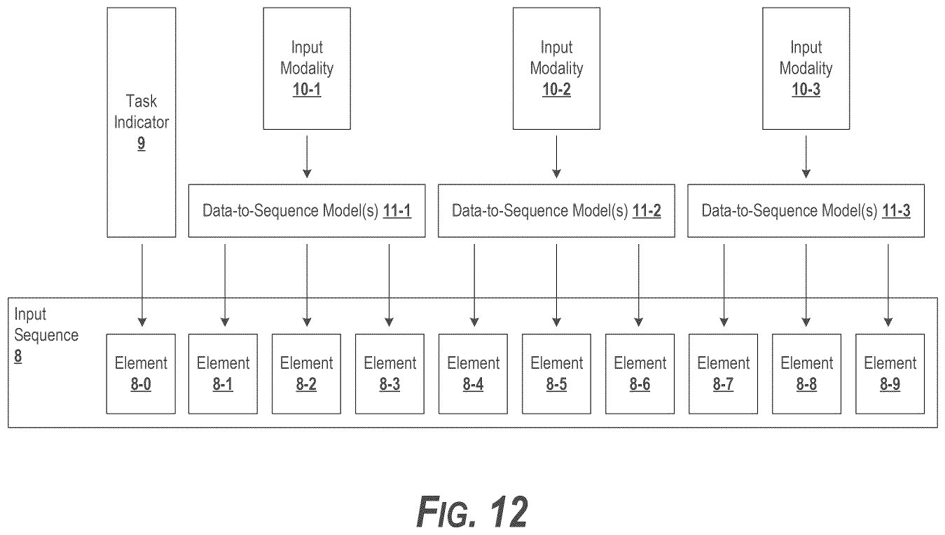

FIG. 12 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

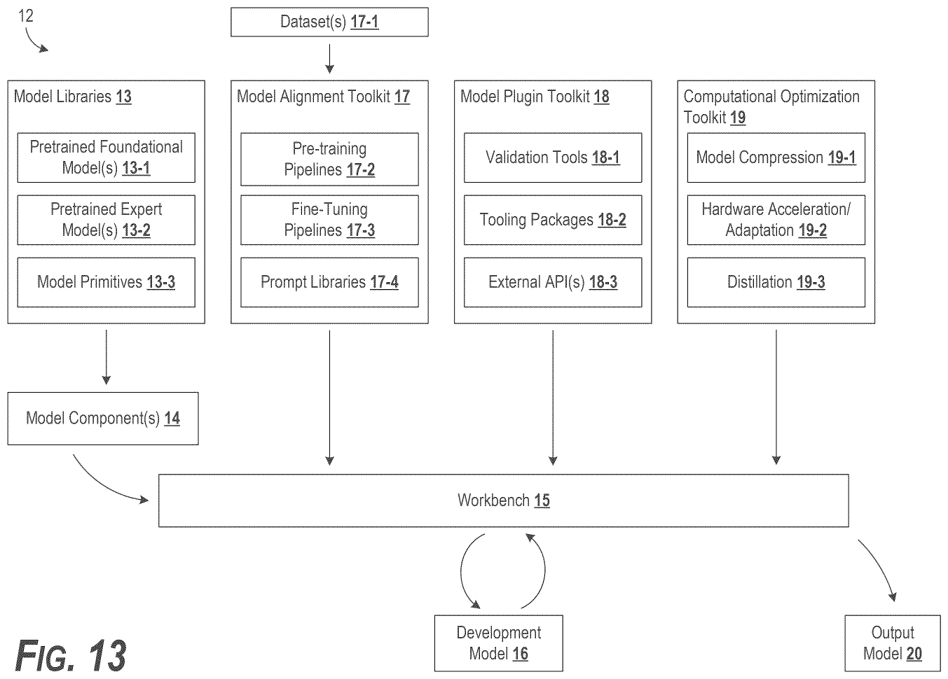

FIG. 13 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 700 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

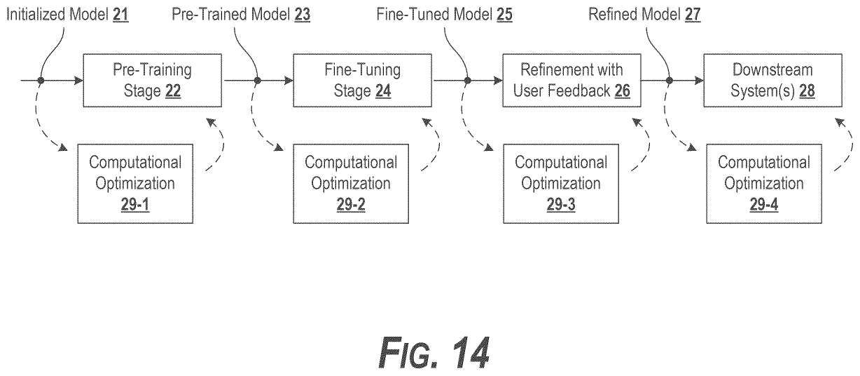

FIG. 14 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 14 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 14 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

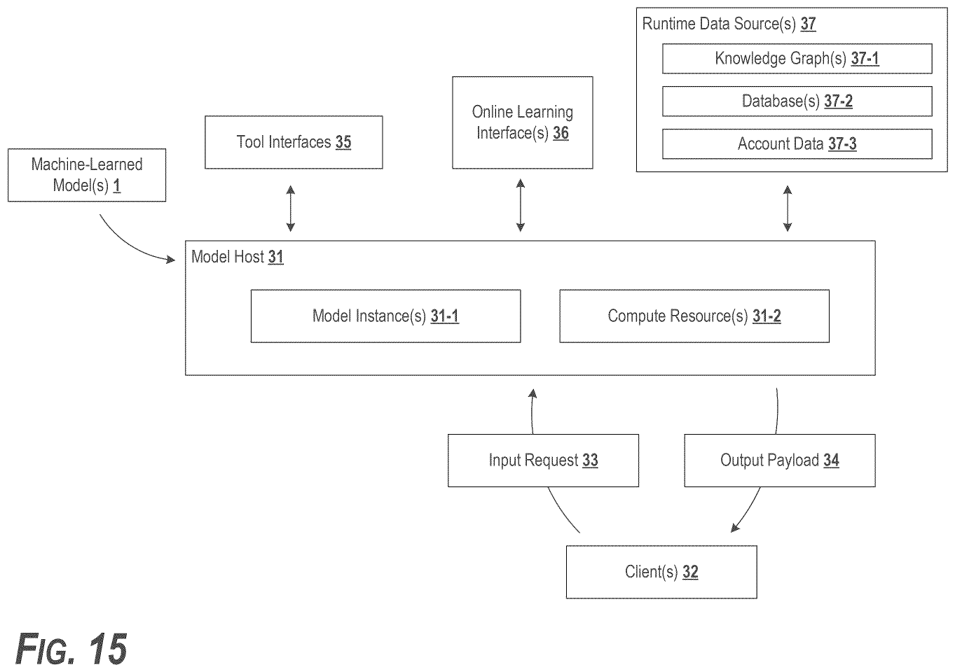

FIG. 15 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

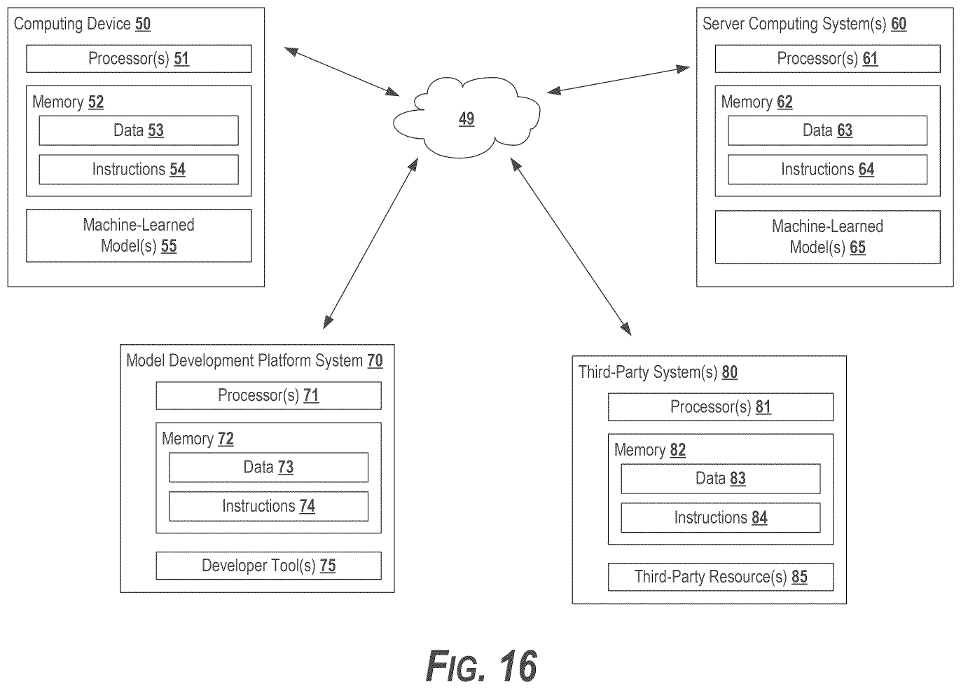

FIG. 16 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 12 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 16 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

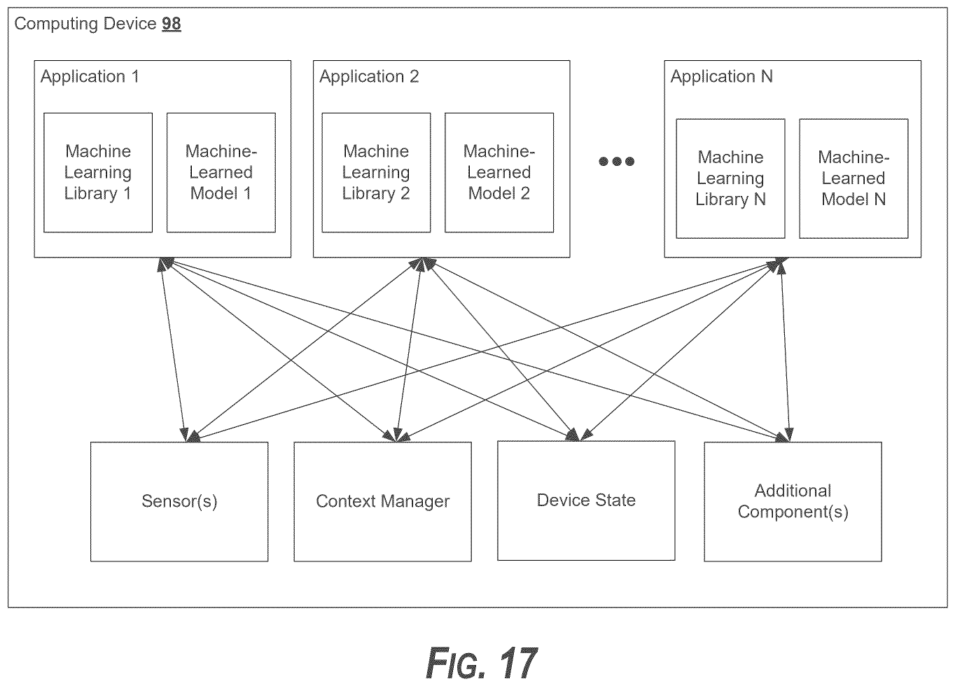

FIG. 1175 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 17, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

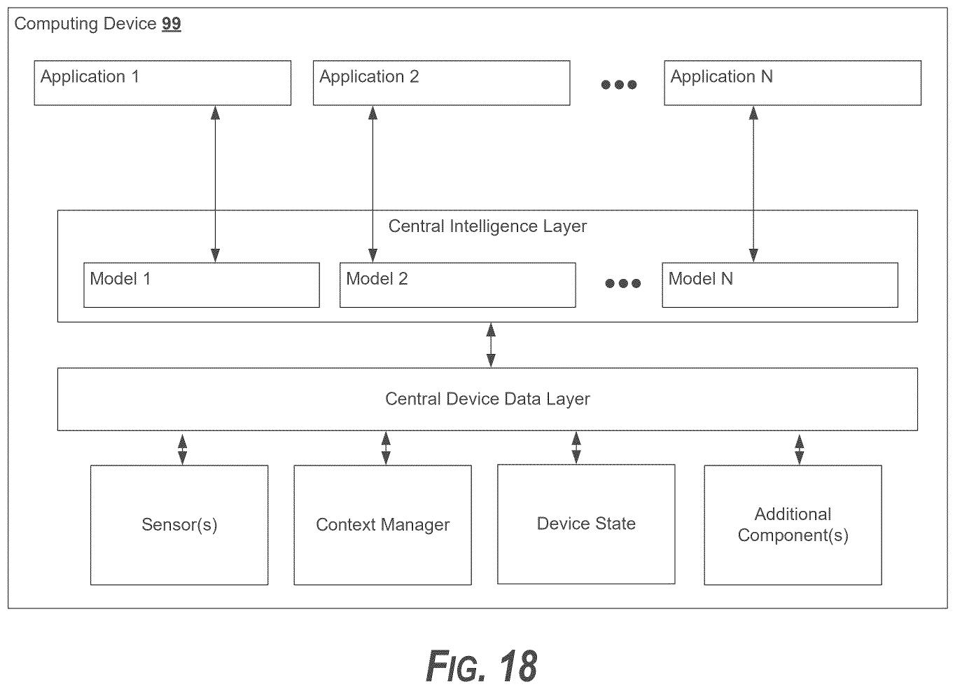

FIG. 18 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 18, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 18, the central device data layer can communicate with a number of other components of the computing device, such as, for example, one or more sensors, a context manager, a device state component, or additional components. In some implementations, the central device data layer can communicate with each device component using an API (e.g., a private API).

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method, comprising:
receiving, by one or more processors, a user query associated with a content item;
providing, by one or more processors, the user query and the content item as input to one or more machine-learned sequence processing models;
generating, by one or more processors as output of the one or more machine-learned sequence processing models, computer-executable functional code configured to process the user query in association with the content item;
generating, by one or more processors, computer-executable interface code for a user interface, the user interface including a user interface element that is associated with at least one parameter of the computer-executable functional code for modifying the content item;
determining, by one or more processors, data for the at least one parameter of the computer-executable functional code based at least in part on a user input to the user interface element; and
generating, by one or more processors, a modified content item using the computer-executable functional code and the data for the at least one parameter.

2. The computer-implemented method of claim 1, wherein generating, by one or more processors computer-executable interface code for a user interface, comprises:
generating the computer-executable interface code using the one or more machine-learned sequence processing models.

3. The computer-implemented method of claim 2, wherein providing, by one or more processors, the user query and the content item as input to the one or more machine-learned sequence processing models, comprises:
generating a first prompt for the one or more machine-learned sequence processing models, the first prompt including the user query and the content item.

4. The computer-implemented method of claim 3, wherein generating the computer-executable interface code using the one or more machine-learned sequence processing models;
generating a second prompt for the one or more machine-learned sequence processing models, the second prompt including the computer-executable functional code.

5. The computer-implemented method of claim 4, wherein the first prompt includes:
data describing a plurality of application programming interfaces associated with a plurality of toolboxes, each toolbox including external code available to the one or more machine-learned sequence processing models.

6. The computer-implemented method of claim 5, wherein the plurality of toolboxes includes at least one of a machine-learned large-language model, a machine-learned text-to-image model, a set of graphics processing unit filters.

7. The computer-implemented method of claim 1, wherein generating, by one or more processors, a modified content item using the computer-executable functional code and the data for the at least one parameter comprises:
modifying, by one or more processors, the content item using the computer-executable functional code including the data for the at least one parameter.

8. The computer-implemented method of claim 1, wherein generating, by one or more processors, a modified content item using the computer-executable functional code and the data for the at least one parameter comprises:
generating, by the computer-executable functional code, a prompt for a machine-learned generative model using the data for the at least one parameter; and
receiving, by the computer-executable functional code from the machine-learned generative model, the modified content item.

9. The computer-implemented method of claim 1, further comprising:
generating, by one or more processors, a response to the user query including the modified content item.

10. The computer-implemented method of claim 1, wherein:
the user interface element is mapped to the at least one parameter of the computer-executable functional code for modifying the content item.

11. The computer-implemented method of claim 1, wherein generating, by one or more processors, the modified content item using the computer-executable functional code comprises:
providing at least one prompt to a machine-learned generative model, the at least one prompt including the content item and the data for the at least one parameter; and
obtaining, as output of the machine-learned generative model, the modified content item.

12. The computer-implemented method of claim 1, wherein generating, by one or more processors, computer-executable interface code for a user interface, comprises:
selecting from a plurality of user interface element types, the user interface element that is associated with the at least one parameter of the computer-executable functional code based on analyzing the at least one parameter of the computer-executable functional code.

13. The computer-implemented method of claim 12, wherein:
the plurality of user interface elements types includes at least one of a drop down menu user interface element type, a slider user interface element type, or a chip user interface element type.

14. A computing system, comprising:
one or more processors; and
one or more computer-readable storage media that collectively store instructions that, when executed by the one or more processors, cause the one or more processors to perform operations, the operations comprising:
receiving a user query associated with a content item;
providing the user query and the content item as input to one or more machine-learned sequence processing models;
generating, as output of the one or more machine-learned sequence processing models, computer-executable functional code configured to process the user query in association with the content item;
generating computer-executable interface code for a user interface, the user interface including a user interface element that is associated with at least one parameter of the computer-executable functional code for modifying the content item;
determining data for the at least one parameter of the computer-executable functional code based at least in part on a user input to the user interface element; and
generating a modified content item using the computer-executable functional code and the data for the at least one parameter.

15. The computing system of claim 14, wherein generating, by one or more processors computer-executable interface code for a user interface, comprises:
generating the computer-executable interface code using the one or more machine-learned sequence processing models.

16. The computing system of claim 15, wherein providing, by one or more processors, the user query and the content item as input to the one or more machine-learned sequence processing models, comprises:
generating a first prompt for the one or more machine-learned sequence processing models, the first prompt including the user query and the content item.

17. The computing system of claim 16, wherein generating the computer-executable interface code using the one or more machine-learned sequence processing models;
generating a second prompt for the one or more machine-learned sequence processing models, the second prompt including the computer-executable functional code.

18. The computing system of claim 17, wherein the first prompt includes:
data describing a plurality of application programming interfaces associated with a plurality of toolboxes, each toolbox including external code available to the one or more machine-learned sequence processing models.

19. The computing system of claim 18, wherein the plurality of toolboxes includes at least one of a machine-learned large-language model, a machine-learned text-to-image model, a set of graphics processing unit filters.

20. One or more computer-readable storage media that store instructions that, when executed by one or more processors, cause the one or more processors to perform operations, the operations comprising:
receiving a user query associated with a content item;
providing the user query and the content item as input to one or more machine-learned sequence processing models;
generating, as output of the one or more machine-learned sequence processing models, computer-executable functional code configured to process the user query in association with the content item;
generating computer-executable interface code for a user interface, the user interface including a user interface element that is associated with at least one parameter of the computer-executable functional code for modifying the content item;
determining data for the at least one parameter of the computer-executable functional code based at least in part on a user input to the user interface element; and
generating a modified content item using the computer-executable functional code and the data for the at least one parameter.
